(19) United States
(12) Patent Application Publication
(10) Pub. No.: US 2023/0318148 A1
(43) Pub. Date: Oct. 5, 2023

(54) BATTERY PACK

(71) Applicant: HONDA MOTOR CO., LTD., Tokyo (JP)

(72) Inventors: Hideki SAKAMOTO, Saitama (JP); Harumi TAKEDOMI, Saitama (JP)

(73) Assignee: HONDA MOTOR CO., LTD., Tokyo (JP)

(21) Appl. No.: 18/127,427

(22) Filed: Mar. 28, 2023

(30) Foreign Application Priority Data
Mar. 30, 2022 (JP) 2022-056563

(51) Int. Cl. H01M 50/507; H01M 50/211; H01M 50/517; H01M 50/271

(52) U.S. Cl. CPC H01M 50/507; H01M 50/211; H01M 50/517; H01M 50/271; H01M 2220/20

(57) ABSTRACT

A battery pack includes a plurality of laminated cells stacked in a horizontal direction, and a battery case accommodating the plurality of laminated cells. The plurality of laminated cells are divided into at least a first cell group and a second cell group. The first cell group and the second cell group are spaced apart. The battery case includes a frame member disposed between the first cell group and the second cell group. The first cell group and the second cell group are electrically coupled by a conductive coupling member. The conductive coupling member includes first conductive coupling members, and a second conductive coupling member. The second conductive coupling member includes a bridge portion, a coupling portion, and a connecting portion connecting the bridge portion and the coupling portion. The coupling portion is disposed below the upper surface of the frame member.

### CROSS-REFERENCE RELATED ARTS

This application is based on and claims priority under 35 USC 119 from Japanese Patent Application No. 2022-056563 filed on Mar. 30, 2022.

### TECHNICAL FIELD

The present disclosure relates to a battery pack mounted on a vehicle.

### BACKGROUND ART

In recent years, researches and development on secondary batteries which contribute to efficiency of energy have been carried out to ensure access to convenient, reliable, sustainable, and advanced energy for more people.

Laminated cells are known as the secondary batteries. For example, JP-A-2007-59088 and JP-A-2012-138268 disclose battery packs in which a plurality of laminated cells are stacked in a vertical direction and accommodated in a case.

However, when the laminated cells are stacked in the vertical direction, gravity of a cell stacked on an upper side acts on a cell on a lower side, and thus a load acting on the cell varies depending on a position of the cell. Although this problem is solved by stacking the laminated cells in a horizontal direction, space saving is required as a further problem.

### SUMMARY

The present disclosure provides a battery pack which can save space and in which laminated cells are stacked in a horizontal direction. Further, the present disclosure contributes to efficiency of energy.

According to an aspect of the present disclosure, there is provided a battery pack disposed under a floor of a vehicle, the battery pack including: a plurality of laminated cells stacked in a horizontal direction; and a battery case accommodating the plurality of laminated cells, in which: the plurality of laminated cells are divided into at least a first cell group and a second cell group; the first cell group and the second cell group are spaced apart; the battery case includes a frame member disposed between the first cell group and the second cell group; the first cell group and the second cell group are electrically coupled by a conductive coupling member; the conductive coupling member includes: first conductive coupling members coupled to cell terminals of the first cell group and the second cell group, respectively; and a second conductive coupling member being plate-shaped and coupling the first conductive coupling members; the second conductive coupling member includes: a bridge portion facing an upper surface of the frame member; a coupling portion coupled to the first conductive coupling member; and a connecting portion connecting the bridge portion and the coupling portion; and the coupling portion is disposed below the upper surface of the frame member.

According to the present disclosure, it is possible to save a space inside the battery case while stacking the laminated cells in the horizontal direction.

### BRIEF DESCRIPTION OF DRAWINGS

FIG. 1 is a schematic perspective view illustrating an internal structure of a battery pack 1.

FIG. 2 is a schematic plan view schematically illustrating a flow of electricity in the battery pack 1.

FIG. 3 is a perspective view of a laminated cell 21.

FIG. 4 is a perspective view of main parts of the battery-pack 1.

FIG. 5 is a cross-sectional view taken along a line A-A of FIG. 4.

FIG. 6 is a perspective view illustrating a coupling process of first conductive coupling members 51 and a second conductive coupling member 52.

FIG. 7 is a perspective view of the second conductive coupling member 52.

FIG. 8 is a cross-sectional view illustrating a second conductive coupling member 52B according to a first modification.

FIG. 9 is a cross-sectional view illustrating a second conductive coupling member 52C according to a second modification.

### DESCRIPTION OF EMBODIMENTS

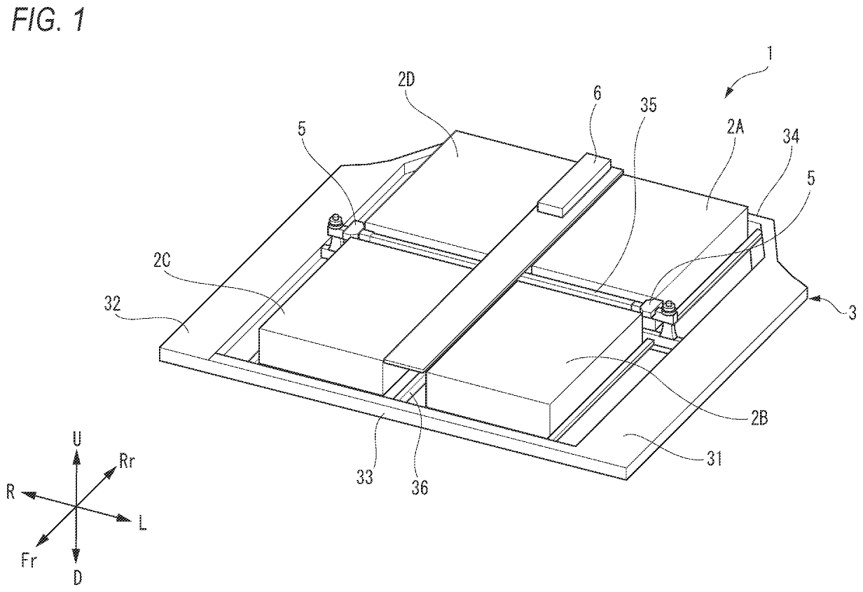

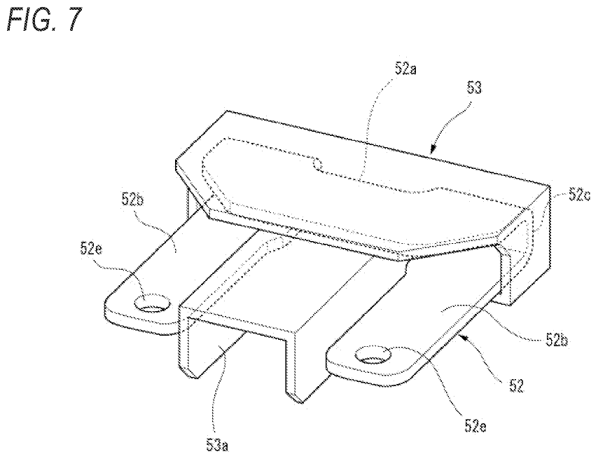

Hereinafter, an embodiment of the present disclosure will be described with reference to FIGS. 1 to 7. The drawings are to be viewed in directions of the reference signs, and in the following descriptions, for simplicity of description, front and rear, left and right, and upper and lower are set, and in the drawings, a front side is represented by Fr, a rear side is represented by Rr, a left side is represented by L, a right side is represented by R, an upper side is represented by U, and a lower side is represented by D for convenience,

(Battery Pack)

As illustrated in FIGS. 1 to 3, a battery pack 1 according to the embodiment of the present disclosure includes a plurality of laminated cells 21 stacked in a horizontal direction (in the embodiment, a left-right direction), and a battery case 3 accommodating the plurality of laminated cells 21, and is disposed under a floor (below a floor panel) of a vehicle (not illustrated), for example.

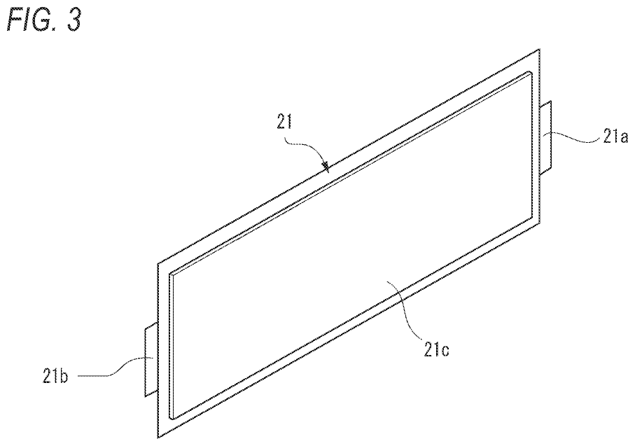

Each of the laminated cells 21 is, for example, a solid-state battery. As illustrated in FIG. 3, the laminated cell 21 formed of the solid-state battery includes a positive electrode to which a positive electrode tab 21a is coupled, a negative electrode to which a negative electrode tab 21b is coupled, a solid electrolyte disposed between the positive electrode and the negative electrode, and a laminate film 21c which accommodates these, and performs charging and discharging by giving and receiving lithium ions between the positive electrode and the negative electrode via the solid electrolyte.

The solid electrolyte is not particularly limited as long as the solid electrolyte has lithium ion conductivity and insulating properties, and a material generally used for an all-solid-state lithium-ion battery may be used. Examples thereof include inorganic solid electrolytes such as sulfide solid electrolyte materials, oxide solid electrolyte materials, and lithium-containing salts, polymer-based solid electrolytes such as polyethylene oxide, and gel-based solid electrolytes containing lithium-containing salts or lithium ion conductive ionic liquids. A form of a solid electrolyte material is not particularly limited, and examples thereof include a particulate form.

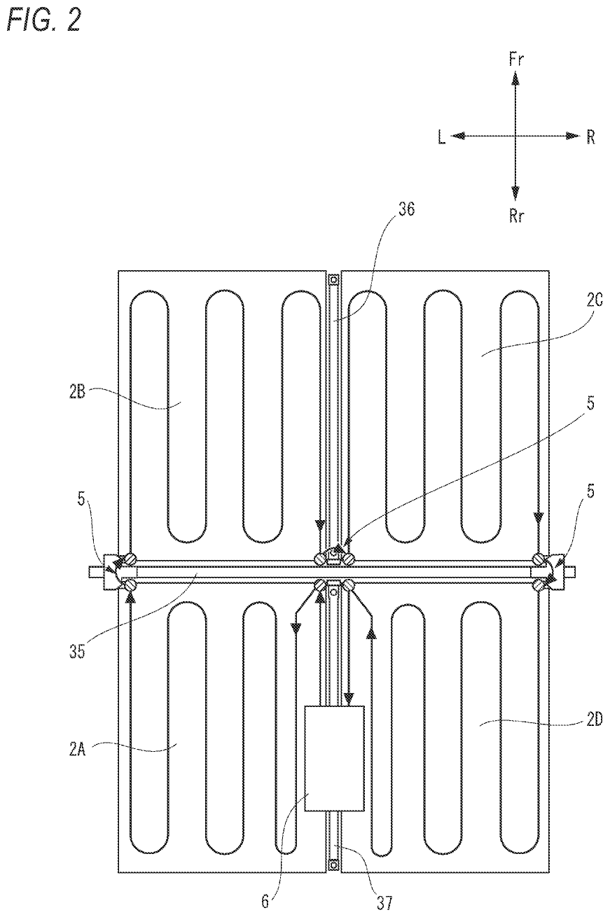

As illustrated in FIGS. 1 and 2, the plurality of laminated cells 21 are divided into a plurality of cell groups 2A to 2D. For example, the battery case 3 is divided into a first cell group 2A disposed at a left rear portion of the battery case 3, a second cell group 2B disposed at a left front portion of the battery case 3, a third cell group 2C disposed at a right front portion of the battery case 3, and a fourth cell group 2D disposed at a right rear portion of the battery case 3. The plurality of cell groups 2A to 2D are spaced apart in the horizontal direction at predetermined intervals.

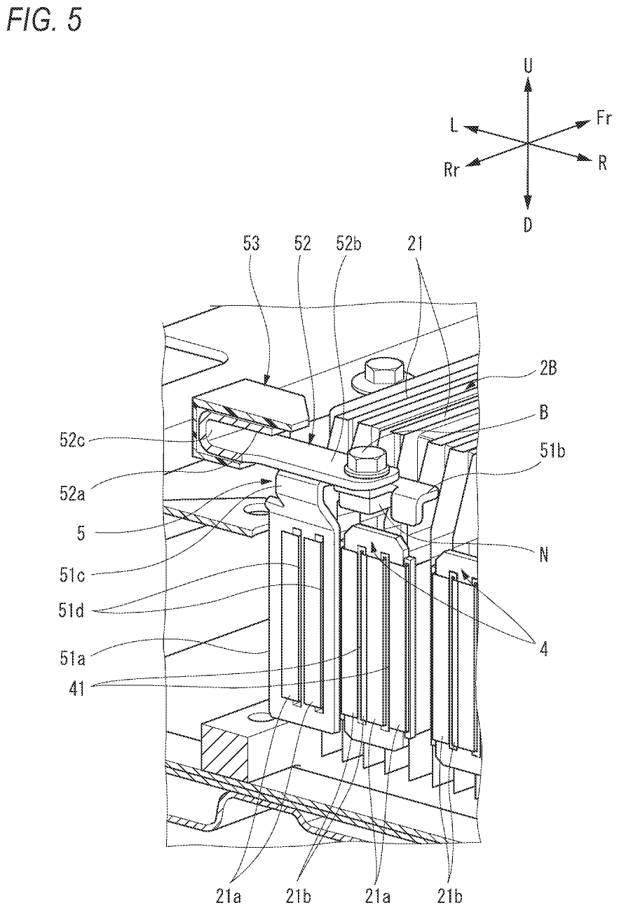

In the plurality of laminated cells 21 constituting the cell groups 2A to 2D, two adjacent laminated cells 21, 21 are coupled in parallel, and the laminated cells 21, 21 coupled in parallel are electrically coupled in series to adjacent laminated cells 21, 21 coupled in parallel. In the embodiment, as illustrated in FIG. 5, adjacent laminated cells 21, 21 are coupled in parallel via an inter-cell coupling member 4, and further adjacent laminated cells 21, 21 are coupled in parallel via the inter-cell coupling member 4, so that the laminated cells 21, 21 coupled in parallel and the laminated cells 21, 21 adjacent thereto are coupled in series.

More specifically, the inter-cell coupling member 4 has two openings 41. The negative electrode tab 21b inserted through one opening 41 and the negative electrode tab 21b extending from one side of the inter-cell coupling member 4 are bent at 90° from the one side to be prevented from coming off, the positive electrode tab 21a inserted through the other opening 41 and the positive electrode tab 21a extending from the other side of the inter-cell coupling member 4 are bent at 90° from the other side to be prevented from coming off, and the tabs 21b, 21h, 21a, and 21a are joined to the inter-cell coupling member 4 in a state where the negative electrode tab 21b inserted through the one opening 41 and the positive electrode tab 21a inserted through the other opening 41 are overlapped with each other. In the plurality of laminated cells 21 constituting the cell groups 2A to 2D, all cells may be coupled in series, and a coupling method is not limited.

Returning to FIG. 2, the cell groups 2A to 2D are electrically coupled in series via conductive coupling members 5. For example, an electrical flow path start of the first cell group 2A is coupled to a wiring coupling box 6, and an electrical flow path end of the first cell group 2A is coupled to an electrical flow path start of the second cell group 2B via a conductive coupling member 5. An electrical flow path end of the second cell group 2B is coupled to an electrical flow path start of the third cell group 2C via a conductive coupling member 5, and an electrical flow path end of the third cell group 2C is coupled to an electrical flow path start of the fourth cell group 2D via a conductive coupling member 5. An electrical flow path end of the fourth cell group 2D is coupled to the wiring coupling box 6. Details of the conductive coupling member 5 will be described later.

As illustrated in FIG. 1, the battery case 3 has a lattice-shaped frame structure in a plan view. As illustrated in FIGS. 1 and 2, the frame structure includes a pair of side frames 31 and 32 facing each other in the left-right direction so as to sandwich the cell groups 2A to 2D, a front frame 33 and a rear frame 34 facing each other in a front-rear direction so as to sandwich the cell groups 2A to 2D, an intermediate horizontal frame 35 disposed between the first cell group 2A and the second cell group 2B and between the third cell group 2C and the fourth cell group 2D, a first intermediate vertical frame 36 disposed between the second cell group 2B and the third cell group 2C, and a second intermediate vertical frame 37 disposed between the first cell group 2A and the fourth cell group 2D. According to such a battery case 3, not only deformation of the battery case 3 at the time of collision can be prevented, but also the cell groups 2A to 2D can be protected from impact at the time of collision.

(Conductive Coupling Member)

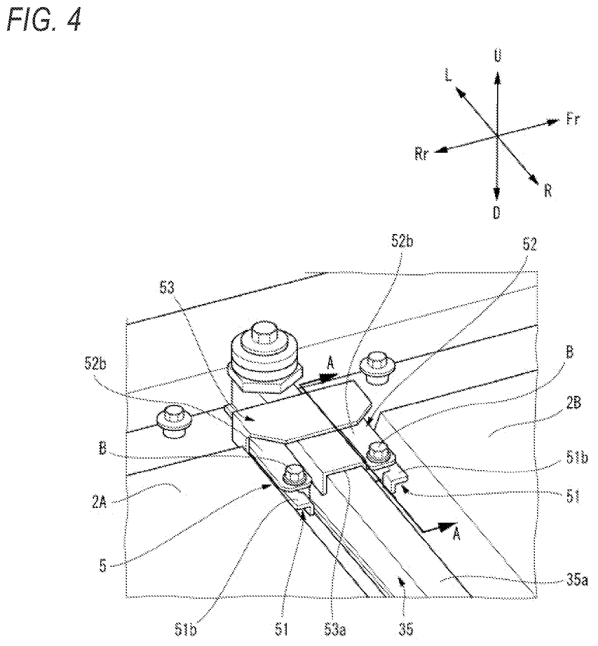

Next, the details of the conductive coupling member 5 will be described with reference to FIGS. 4 to 7. In the following description, the conductive coupling member 5 which couples the first cell group 2A and the second cell group 2B will be described, and the conductive coupling member 5 which couples the second cell group 2B and the third cell group 2C and the conductive coupling member 5 which couples the third cell group 2C and the fourth cell group 2D have a similar configuration.

As illustrated in FIGS. 4 to 7, the conductive coupling member 5 includes a first conductive coupling member 51 coupled to the negative electrode tabs 21b, 21b of the laminated cells 21, 21 coupled in parallel and positioned at the electrical flow path end of the first cell group 2A, a first conductive coupling member 51 coupled to the positive electrode tabs 21a, 21a of the laminated cells 21, 21 coupled in parallel and positioned at the electrical flow path start of the second cell group 2B, a second conductive coupling member 52 coupling these first conductive coupling members Si to each other, and an insulating cover 53 covering a part of the second conductive coupling member 52, The first conductive coupling member 51 and the second conductive coupling member 52 are plate-shaped members formed by press-bending a conductive plate material.

As illustrated in FIGS. 4 to 7, the second conductive coupling member 52 includes a bridge portion 52a facing an upper surface 35a of the intermediate horizontal frame 35, a pair of coupling portions 52b coupled to the first conductive coupling member 51, and a connecting portion 52c connecting the bridge portion 52a and the pair of coupling portions 52b. The bridge portion 52a and the coupling portion 52b extend in the horizontal direction, and the connecting portion 52c extends in a vertical direction.

The pair of coupling portions 52b is disposed below the upper surface 35a of the intermediate horizontal frame 35. According to such a second conductive coupling member 52, when the second conductive coupling member 52 straddles the intermediate horizontal frame 35, heights of the pair of coupling portions 52b are reduced, and thus space saving can be achieved.

As illustrated in FIG. 5, the first conductive coupling member 51 includes a plate-shaped cell coupling member 51a to which the positive electrode tabs 21a, 21a or the negative electrode tabs 21b, 21b of the laminated cells 21, 21 are coupled, a coupling portion 51b coupled to the coupling portion 52b of the second conductive coupling member 52, and a connecting portion 51c connecting the cell coupling member 51a and the coupling portion 51b. The cell coupling member 51a extends along the vertical direction, and the coupling portion 51b extends along the horizontal direction.

The cell coupling member 51a has two openings 51d through which the positive electrode tabs 21a, 21a or the negative electrode tabs 21b, 21b can be inserted. The positive electrode tabs 21a, 21a or the negative electrode tabs 21b, 21b coupled to the cell coupling member 51a extend from the laminated cell 21 toward an intermediate horizontal frame 35 side and are inserted into the openings 51d. The positive electrode tabs 21a, 21a or the negative electrode tabs 21b, 21b inserted into the openings 51d are bent by 90° to be prevented from coming off, and then are electrically coupled through a joining process.

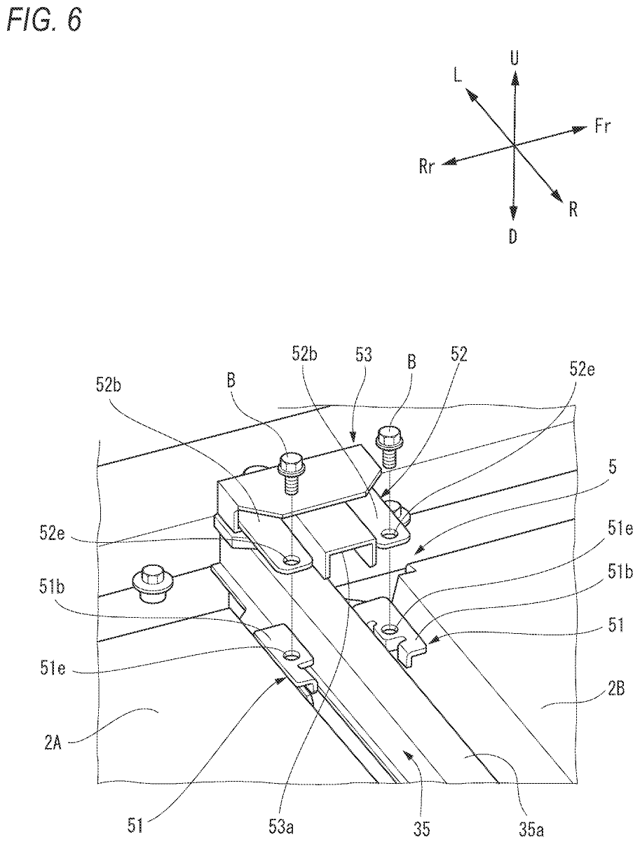

As illustrated in FIG. 6, the coupling portion Sib of the first conductive coupling member 51 faces the coupling portion 52b of the second conductive coupling member 52 in the vertical direction, and surfaces of the coupling portion 51b and the coupling portion 52b are fixed to each other by bolts B and nuts N inserted through bolt holes 51e of the coupling portion Sib and bolt holes 52e of the coupling portion 52b. Accordingly, the first conductive coupling member 51 and the second conductive coupling member 52 can be reliably coupled to each other, and poor contacting can be prevented. The nuts N are preferably fixed in advance to a lower surface side of the coupling portion 51b of the first conductive coupling member 51 by welding or the like.

As illustrated in FIGS. 4 to 7, the insulating cover 53 covers the bridge portion 52a and the connecting portion 52c of the second conductive coupling member 52 in order to insulate at least the second conductive coupling member 52 and the intermediate horizontal frame 35 from each other. The insulating cover 53 includes a fitting portion 53a which fits into the intermediate horizontal frame 35 from an upper side when the first conductive coupling member 51 and the second conductive coupling member 52 are coupled to each other. According to such a fitting portion 53a, since rotation of the second conductive coupling member 52 can be restricted at the time of bolt fastening, a bolt fastening operation is facilitated.

(Modification of Second Conductive Coupling Member)

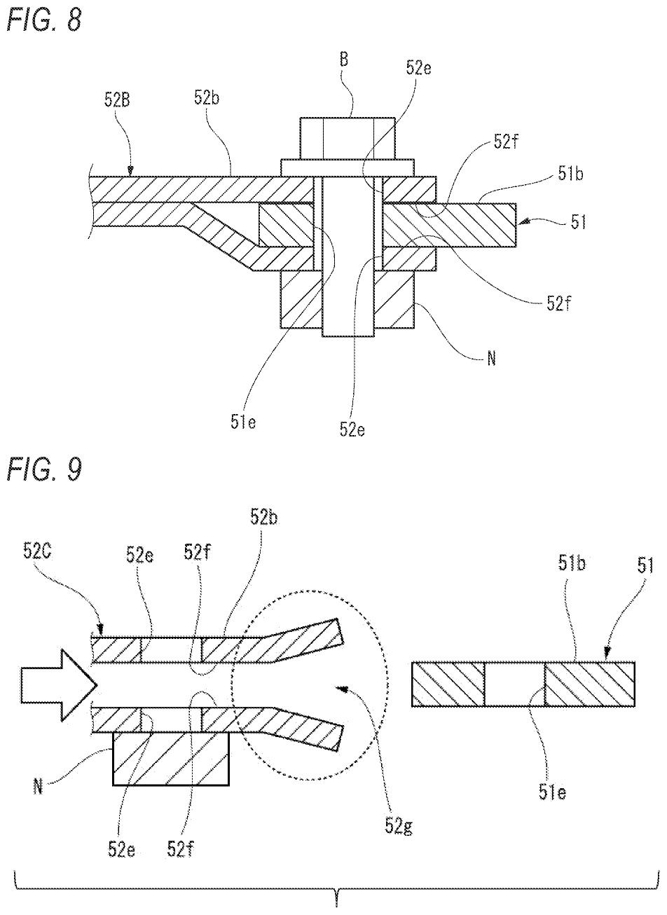

Next, second conductive coupling members 52B and 52C according to a first modification and a second modification will be described with reference to FIGS. 8 and 9. The same reference signs as those of the second conductive coupling member 52 described above are used for the same configurations as those of the second conductive coupling member 52 described above, and the description of the second conductive coupling member 52 described above may be incorporated.

As illustrated in FIGS. 8 and 9, the second conductive coupling members 52B and 52C according to the first modification and the second modification are different from the second conductive coupling member 52 described above in that the coupling portion 52b has two surfaces 52f spaced apart from each other in the vertical direction, and the coupling portion 51b of the first conductive coupling member 51 is disposed between the two surfaces 52f. In the second conductive coupling members 52B and 52C according to the first modification and the second modification, the nuts N are preferably fixed in advance to a lower surface side of the coupling portion 52b by welding or the like. According to the second conductive coupling members 52B and 52C of the first modification and the second modification, it is possible to reduce a torque reaction force at the time of bolt fastening and firmly fix the first conductive coupling member 51 and the second conductive coupling members 52B and 52C.

As illustrated in FIG. 9, the second conductive coupling member 52C according to the second modification is different from the second conductive coupling member 52B according to the first modification in that two surfaces 52f have a receiving port 52g formed such that a distance between the two surfaces 52f increases as the two surfaces 52f are away from the bolt holes 52e in an insertion direction of the first conductive coupling member 51. According to the second conductive coupling member 52C of the second modification, it is easy to insert the first conductive coupling member 51 between the two surfaces 52f of the second conductive coupling member 52C.

Although various embodiments are described above with reference to the drawings, it is needless to say that the present invention is not limited to such examples. It is apparent to those skilled in the art that various changes and modifications can be conceived within the scope of the claims, and it is also understood that such changes and modifications naturally belong to the technical scope of the present invention. Constituent elements in the above embodiment may be combined freely within a range not departing from the spirit of the invention.

At least the following matters are described in the present specification, Although the corresponding constituent elements or the like in the above embodiment are shown in parentheses, the present invention is not limited thereto.

(1) A battery pack (battery pack 1) disposed under a floor of a vehicle including:
a plurality of laminated cells (laminated cells 21) stacked in a horizontal direction; and
a battery case (battery case 3) accommodating the plurality of laminated cells, in which:
the plurality of laminated cells are divided into at least a first cell group (first cell group 2A) and a second cell group (second cell group 2B);
the first cell group and the second cell group are spaced apart;
the battery case includes a frame member (intermediate horizontal frame 35) disposed between the first cell group and the second cell group;
the first cell group and the second cell group are electrically coupled by a conductive coupling member (conductive coupling member 5); and
the conductive coupling member includes:
   first conductive coupling members (first conductive coupling members 51) coupled to cell terminals (positive electrode tab 21a, negative electrode tab 21b) of the first cell group and the second cell group, respectively; and
   a second conductive coupling member (second conductive coupling member 52, 52B, 52C) being plate-shaped and coupling the first conductive coupling members;
the second conductive coupling member includes:
   a bridge portion (bridge portion 52a) facing an upper surface (upper surface 35a) of the frame member;
   a coupling portion (coupling portion 52b) coupled to the first conductive coupling member; and
   a connecting portion (connecting portion 52c) connecting the bridge portion and the coupling portion; and
the coupling portion is disposed below the upper surface of the frame member,
According to (1), since the coupling portion of the second conductive coupling member is disposed below the upper surface of the frame member, a space inside the battery case can be saved.
(2) The battery pack according to (1), in which
surfaces of the first conductive coupling member and the second conductive coupling member facing each other in a vertical direction are fixed to each other by bolts (bolts B).

According to (2), the surfaces of the first conductive coupling member and the second conductive coupling member face each other and are fixed to each other by the bolts, so that the first conductive coupling member and the second conductive coupling member can be reliably coupled to each other and poor contacting can be prevented.
(3) The battery pack according to (2), in which:
the coupling portion of the second conductive coupling member has two surfaces surfaces 52f) spaced apart in the vertical direction; and
the first conductive coupling member is disposed between the two surfaces of the second conductive coupling member.

According to (3), a torque reaction force at the time of bolt fastening can be reduced.
4) The battery pack according to (3), in which
the two surfaces of the second conductive coupling member have a receiving port (receiving port 52g) formed such that a distance between the two surfaces increases as the two surfaces are away from bolt holes (bolt holes 52e) in an insertion direction of the first conductive coupling member.

According to (4), the first conductive coupling member and the second conductive coupling member can be easily assembled.
(5) The battery pack according to any one of (1) to (4), in which:
at least a part of the second conductive coupling member is covered with an insulating cover (insulating cover 53); and the insulating cover includes a fitting portion (fitting portion 53a) which fits into the frame member.

According to (5), the fitting portion of the insulating member prevents rotation of the second conductive coupling member at the time of bolt fastening. Accordingly, the insulating member can be used not only as insulation for the second conductive coupling member but also as a rotation lock member.
(6) The battery pack according to any one of (1) to (5), in which:
the cell terminals of the first cell group and the second cell group, which are electrically coupled to the first conductive coupling member, extend toward a frame member side; and
the first conductive coupling member includes:
   a cell coupling portion (cell coupling member 51a) being plate-shaped,
the cell coupling portion having openings (openings 51d) through which the cell terminals are inserted and extending in a vertical direction,
   a coupling portion (coupling portion 51b) coupled to the coupling portion of the second conductive coupling member; and
   a connecting portion (connecting portion 51c) connecting the cell coupling portion and the coupling portion.

According to (6), the cell terminals of the first cell group and the second cell group can be brought close to the frame member, and a space inside the battery case can be further saved,
(7) The battery pack according to any one of (1) to (6), in which
the laminated cells are solid-state batteries.

According to (7), since an energy density is high, a larger number of laminated cells can be arranged.

What is claimed is:

1. A battery pack disposed under a floor of a vehicle, the battery pack comprising:
a plurality of laminated cells stacked in a horizontal direction; and
a battery case accommodating the plurality of laminated cells, wherein:
the plurality of laminated cells are divided into at least a first cell group and a second cell group;
the first cell group and the second cell group are spaced apart;
the battery case includes a frame member disposed between the first cell group and the second cell group;
the first cell group and the second cell group are electrically coupled by a conductive coupling member;
the conductive coupling member includes:
first conductive coupling members coupled to cell terminals of the first cell group and the second cell group, respectively; and
a second conductive coupling member being plate-shaped and coupling the first conductive coupling members;
the second conductive coupling member includes:
a bridge portion facing an upper surface of the frame member;
a coupling portion coupled to the first conductive coupling member; and
a connecting portion connecting the bridge portion and the coupling portion; and
the coupling portion is disposed below the upper surface of the frame member.

2. The battery pack according to claim 1, wherein
surfaces of the first conductive coupling member and the second conductive coupling member facing each other in a vertical direction are fixed to each other by bolts.

3. The battery pack according to claim 2, wherein:
the coupling portion of the second conductive coupling member has two surfaces spaced apart in the vertical direction; and
the first conductive coupling member is disposed between the two surfaces of the second conductive coupling member.

4. The battery pack according to claim 3, wherein
the two surfaces of the second conductive coupling member have a receiving port formed such that a distance between the two surfaces increases as the two surfaces are away from bolt holes in an insertion direction of the first conductive coupling member.

5. The battery pack according to claim 1, wherein:
at least a part of the second conductive coupling member is covered with an insulating cover; and
the insulating cover includes a fitting portion which fits into the frame member.

6. The battery pack according to claim 1, wherein:
the cell terminals of the first cell group and the second cell group, which are electrically coupled to the first conductive coupling member, extend toward a frame member side; and
the first conductive coupling member includes:
a cell coupling portion being plate-shaped, the cell coupling portion having openings through which the cell terminals are inserted and extending in a vertical direction;
a coupling portion coupled to the coupling portion of the second conductive coupling member; and
a connecting portion connecting the cell coupling portion and the coupling portion.

7. The battery pack according to claim 1; wherein
the laminated cells are solid-state batteries.
